(19) United States
(12) Patent Application Publication
(10) Pub. No.: US 2006/0084336 A1
(43) Pub. Date: Apr. 20, 2006

(54) High strength lightweight composite fabric with low gas permeability

(75) Inventors: Charles A. Howland, Temple, NH (US); W. Neal Bebber, Matthews, NC (US); Gregory D. Williams, Matthews, NC (US)

Correspondence Address: MAINE & ASMUS, 100 MAIN STREET, P O BOX 3445, NASHUA, NH, 03061-3445, US

(73) Assignee: WARWICK MILLS, INC., New Ipswich, NH (US)

(21) Appl. No.: 11/046,403

(22) Filed: Jan. 28, 2005

Related U.S. Application Data
(63) Continuation-in-part of application No. 09/927,034, filed on Aug. 9, 2001, now abandoned.
Application No. 09/927,034 is a continuation-in-part of application No. 09/371,474, filed on Aug. 10, 1999, now abandoned.

(51) Int. Cl. B32B 27/04; B32B 27/12; D03D 15/00; B32B 25/10; B32B 5/02

(52) U.S. Cl. 442/65; 442/286; 442/293; 442/189; 442/64; 442/66

(57) ABSTRACT

A flexible laminate for airship or gas enclosure applications, having a load bearing woven fabric core layer of high strength, low twist yarns, an interior side gas barrier layer, a yarn to fabric strength ratio of between about 1.36 and 1.8, a limited yarn twist, and a yarn height to width ratio of between about 1:2 and 1:7. There is an interior side gas barrier layer on one side of the load bearing layer preferably consisting of polyurethane and an exterior side layer on the other side of the load bearing layer which includes in sequence a first layer of polyurethane, a layer of film, a second layer of polyurethane, and an outermost layer of polymeric material. The laminated structure preferably has a gas transmission rate of not more than about 30 cubic centimeters in 24 hours through a one meter square area at a one atmosphere pressure differential.

This application is a continuation-in-part to pending application Ser. No. 09/927,034, filed Aug. 09, 2001, which is a continuation of application Ser. No. 09/371,474, filed Aug. 10, 1999, now abandoned.

### FIELD OF THE INVENTION

The present invention relates to lighter-than-air vehicles such as airships, aerostats, blimps, and balloons, and in particular relates to a flexible, load bearing laminate structure for containing gas under pressure as is required for the hull or skin of such vehicles.

### BACKGROUND OF THE INVENTION

The present invention relates to lighter-than-air (LTA) vehicles. Although in layman's terms, they are often called blimps, the terminology can be more properly expressed using the following categories (among others). In this regard, the term “aerostat” is often used to describe a tethered lighter-than-air vehicle filled with a gas, with a hull fabricated from sheet material, and usually a stabilizing tail assembly that gives the vehicle aerodynamic stability. When a large LTA vehicle is formed that includes internal structure of some sort, a plurality of internal gas bags and an on-board propulsion system, it is typically referred to as an “airship”. The term “dirigible” is also typically used to refer to this type of LTA vehicle. When the LTA vehicle is formed of a gull or balloon structure that requires no internal separation of gas bags, and which essentially is made up of single chamber, it is more typically referred to as a “blimp”. As will be seen from the detailed description and claims that follow, the difference between and among these terms is not of particular significance to the present invention, and thus the terms can be used interchangeably for purposes of describing the invention, even though those with skill in this are recognize that particular differences in these terms.

An airship gains its lift from Archimedes' principle; i.e., the physical law by which objects immersed in a fluid are buoyed by a force equivalent to the weight of the displaced fluid. Because an aerostat does not gain its lift from the movement of air over an airfoil, but rather form the amount of air that it displaces with a lighter-than air gas, the airship with the greatest lift on a proportional basis are those which weigh the least based on the volume of air that they displace.

For most particular purposes, some of the factors affecting the lift of an airship on a volume basis are generally fixed. For example, although molecular hydrogen (H₂) is the least dense gas (two grams per mole) available for filling airships, and thus the most efficient from a weight standpoint, it is highly explosive, must be handled very carefully, and presents a constant risk. Thus, hydrogen gas is generally less favored for commercial aerostats because of these issues. Helium (He) weighs four (4) grams per mole, and thus is proportionally twice as heavy as hydrogen. Because helium is an inert gas, however, it eliminates the flammability issue as well as many other chemical reaction problems that can occur with other gases. Accordingly, helium is the gas of choice for most airship applications. As a result, the fixed weight of a particular volume of a selected gas fro an aerostat remains the same regardless of the construction of the aerostat. As known to those of even basic skill in chemistry, the weight of a given volume of a gas can be calculated to a useful degree of accuracy using fundamental relationships such as Avogadro's Law, and the ideal gas law.

Accordingly, the main factor in reducing the weight of an airship on a per volume basis is to reduce the weight of the other materials that go into the physical structure, reducing the hull's weight on a per-unit basis remains a useful goal in this art.

First and foremost, however, the hull must provide an efficient gas barrier. It must exhibit low gas permeability or in other words have low gas transmission characteristics. Generally speaking, the hull material or skin of an airship should also provide the ideal combination of at least the following additional factors: flex fatigue (the resistance to failure under repeated bending loads), tensile strength (the ability to resist breaking under tension), slit tear resistance (the ability to resist rupture from tearing), adhesion (the degree to which surfaces are held together by interfacial forces), thickness, joint performance (i.e., joints between adjacent segments of material should be at least as strong as the material itself, and preferably stronger), predictable crimp (for fabric layers), and proper elongation under load (the degree to which a fabric wills stretch at a specified load or at a breaking point).

In order to meet these various requirements, the hulls of more modern airships are conventionally formed of a multiple-layer material, usually in the form of a laminate in which the layers are fixed to one another either through mechanical or chemical adhesion, or through the use of filling or tie layers of polymeric materials that provide the desired gas barrier properties as well as the mechanical properties otherwise desired in the laminate. Perhaps a most typical recent laminate structure is set forth in U.S. Pat. No. 5,188,558 to named inventors Mater et al. The Mater structure is a series of layers of both polymers and fabric and film material laminated to one another in an attempt to provide the strength and fatigue characteristics desired while remaining the necessary gas barrier properties.

As used herein, the term “laminated fabric” represents a fabric composed of high-strength reinforcing scrim or base fabric between two plies of flexible thermoplastic film. In most laminates this type, the polymers on both faces of the fabric can, will, and indeed are intended to, flow through the interstices, and bond to the fabric.

As set forth in the Mater '558 patent, the laminate includes a base woven fabric (illustrated at 24 in the '558 patent) that provides much of the structural characteristics of his overall laminate.

In heavy load cargo airship applications, however, fabrics the same as or similar to the Mater '558 patent tend to form the woven fabric which is thick and bulky. If typical industrial polyester fiber is used the strength of the fiber and the demand of these larger airships leads to a very large yarn of perhaps 6-10,000 denier. The alternates is to use high-strength synthetic materials such as aromatic polyamides, one example of which is available from DuPont under the Kevlar® trademark or liquid crystal polyester (e.g., Vectran®) in the form of highly twisted yarns in a plain woven structure (e.g., U.S. Pat. Nos. 5,837,623 and 5,565,264). Even if the fibers have tenacities of 20 grams per denier the yarns required become thick and bulky with the typical levels. Because of these strength requirements for the hull material, the yarns, and thus the wave, are typically formed very thick. In turn, the amount of polymer used to fill in the wave in order to provide both adhesion and the gas barrier tends to be quite high. Stated differently, the use of big, bulky high-strength, high-twist yarns produces a relatively thick woven structure which requires a large amount of polymer (typically polyurethane) to seal it. As a result, the hull materials formed from bulky yarns, bulky weaves, and thick polyurethane, coatings tend to have a weight of about 35 ounces per square yard. Although such a material is certainly “lightweight” in conventional terms, an airship of practical cargo or passenger carrying capability will include thousands of square yards of such material. For example, an airship or aerostat with 40,000 square yards of skin would include almost 88,000 pounds (almost 44 tons) of laminate material. Accordingly, reducing the weight of the hull material is one way to reduce the overall weight of the entire airship on a proportional basis. Nevertheless, given the safety requirements for both cargo and passengers that are required before a commercial airship can be put into use, the strength requirements for the hull material cannot be compromised.

Accordingly, a need exists for improved airship hull materials that maintain all of the physical requirements of conventional materials, but which weigh significantly less on a proportional basis.

### SUMMARY OF THE INVENTION

Therefore, it is an object of the present invention to provide laminate structures for airship hull materials that provide all the gas barrier, strength, and other mechanical properties required of such material, but at a significantly lower weight on proportional basis.

The invention meets this object with a laminate for high-strength, low-weight gas enclosure applications such as aerostats or airships. The laminate comprises at least one woven fabric layer with an aggregate strength greater than 10 grams per denier. The yarns and fabric have sufficient twist to provide the desired tensile conversion of the fiber, but less than the amount of twist that would produce an unsatisfactory, thick, heavy laminate. The fabric has a yarn-to-fabric strength ratio sufficient to impart tear resistance to the fabric, and integrity for the fabric to be manufactured into laminate; yet not reduce the tear performance of the fabric. One or more gas barrier materials are laminated to the fabric layer to complete the overall structure.

The foregoing and other objects an advantages of the invention and the manner in which the same are accomplished will become clearer based on the following detailed description taken in conjunction with accompanying drawings in which:

### BRIEF DESCRIPTION OF THE DRAWINGS

FIG. 1 is an overall perspective view of an airship that can take advantage of the present invention;

FIG. 2 is a cutaway, partial cross-sectional view of a laminate according to the present invention;

FIG. 3 is perspective view of the woven fabric of the laminate of the present invention;

FIG. 4 is a cross-sectional view of the laminate of the invention taken along lines 4-4 of FIG. 2;

FIG. 5 is a cross-sectional view of a prior art laminate material for airships;

FIG. 6 is a schematic plot of flex fatigue versus twist for fabrics used in load bearing applications such airship laminates; and

FIGS. 7A and 7B are cross section illustrations of a woven fabric comparing available crossing points to formed crossing points to demonstrate the meaning of “available crossing points formed” in a planar structure made of intersecting yarns.

### DETAILED DESCRIPTION OF THE INVENTION

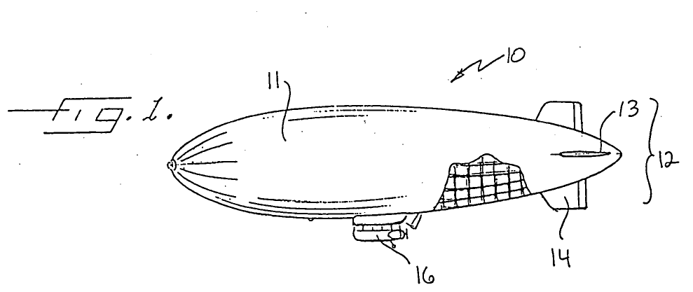

FIG. 1 is a perspective view of an airship generally designated at 10. As noted above, the airship 10 is also sometimes referred to as a “blimp,” “dirigible.” Each of these structures has the same features for the purposes of the present invention, and thus it will be understood that the invention applies to each type of airship, regardless of how it may be named in a particular application. Those of skill in this art will thus recognized that the invention is not limited to a particular classification of airship, but offers advantages regardless of the type of airship into which it may be incorporated.

As illustrated in FIG. 1, the airship 10 includes the gas envelope 11, and the tail assembly indicated by the brackets at 12. In most typical applications, the tail assembly 12 comprises both horizontal and vertical members 13 and 14 respectively. In aerostat applications in which the aerostat is tethered or otherwise maintained in a single position, the vertical and horizontal tail members 14 and 13 can be static. In applications for airships or blimps that are used in travel from place to place, the tail members 13 and 14 are typically tillable to provide additional aerodynamic control. These features are generally well known in the art and will not be discussed in detail herein as the invention is applicable to aerostats with either type of tail assembly.

FIG. 1 also indicates that in certain applications, the airship 10 can include an internal framework 15 that provides additional structural stability to the overall airship. Internal structures such as the structure 15 shown in FIG. 1 add a great deal of weight, however, and one of the advantages of the present invention is its capacity for forming a relatively large single gas envelope that has sufficient integrity to be used without such a framework and it thus provides significant weight advantages in many applications. In certain circumstances, the gas envelope 11 can be formed of a series of panels that are fixed together in an appropriate fashion to form the overall envelope 11. The panels can be welded together in a manner that provides integrity to the welds that are as strong or preferably stronger than the integrity of the gas envelope material itself. Stated differently, and this will be seen with respect to the present invention, the capability of the laminate to be welded should be such that the resulting welds are stronger than the fabric from which the welds are joined. Ideally, the fabric should fail in by breaking the fiber before the welds break.

The internal framework 15 is preferably formed of the most lightweight material capable of meeting the engineering requirements for the aerostat and is preferably selected from the group consisting of metals, polymers, composites formed of fibers and polymers, and combinations of these materials.

The airship 10 illustrated in FIG. 1 similarly can include a propulsion system designated as part of the gondola 16 suspended from the hull of the airship 10. Particular propulsion systems are well know in the art and will not be described in detail herein. IN general; a conventional internal-combustion engine and propeller are preferred.

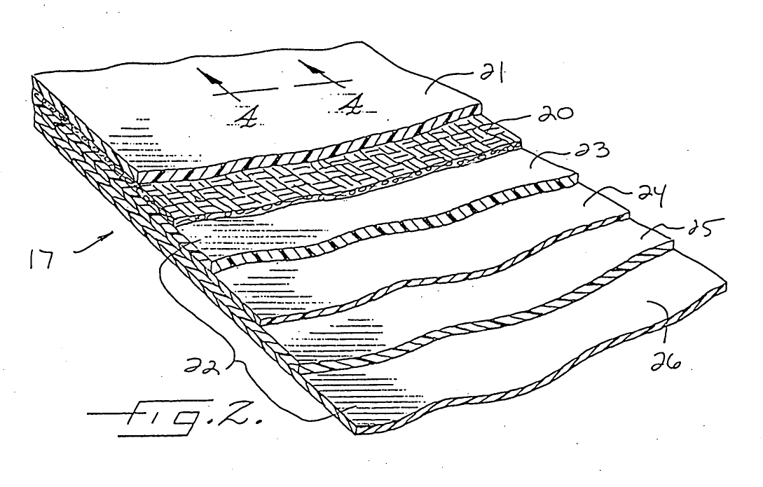

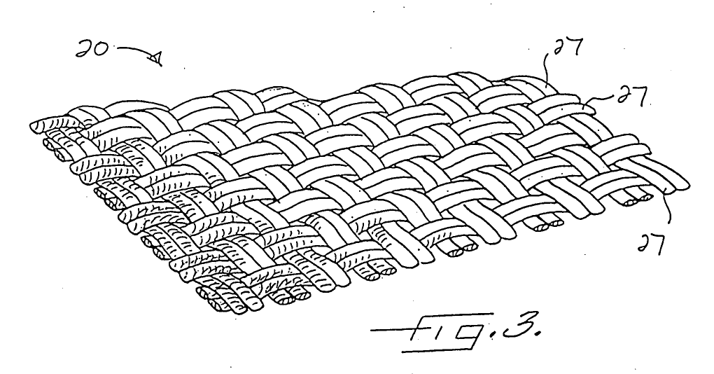

FIGS. 2 and 3 illustrate some of the primary features of the present invention. FIG. 2 is a cutaway perspective view of the laminate material broadly designated at 17 that forms the gas envelope 1 of an airship. In the view of FIG. 2, the upper portions of the laminate comprise the interior or “helium” side of the laminate, while the bottom portions from the outer or “weather” side of the laminate.

In the present invention, the laminate comprises at least one woven fabric layer 20 with an aggregate strength than ten grams per denier. Denier is used herein in its conventional sense, i.e., as a weight-per-unit-length measure of any linear material. In its most formal sense, denier is the weight in grams of 9,000 meters of the material; e.g., Hoechst Celanese Dictionary of Fiber & Textile Technology, Hoechst Celanese Corporation (1990); Tortora, Fairchild's Dictionary of Textiles, 7th Ed., Capital Cites Media, Inc. (1996).

In fabrics according to the present invention, the strength per denier is taken in an aggregate sense and can represent that of the individual fibers, the yarn, the plies or the weave, provided that the strength requirement of ten grams denier is met.

The yarns in the fabric of the present invention have sufficient twist to provide the desired textile conversion, but less than the amount of twist that would produce unsatisfactory thick and heavy fabric. Thus, in a numerical sense, using a 1500 denier yarn of 1.4 specific gravity, yarns of this description are considered to be “low twist” which is typically taken as being a twist of less than about 240 turns per meter, or less than six (6) turns per inch. Again using the 1500 denier example, twists of less than 118 turns per meter and less than three (3) turns per inch, and in some cases less than one (1) turn per inch, are most preferred. The helix angles achieved with this yarn represent the design factor. As in all twist calculations the twist must be adjusted based on denier to achieve a consistent helix angle.

The term “helix angle, as used herein, means the apparent angle of intersection of the fibers within a straight section of the yarn to the center line or axis of the yarn section, generated by the twist in the yarn, as viewed from a position normal to the lengthwise direction of the yarn section. In the example above, the helix angle observed from a position normal to a straight section of yarn of 1500 denier Vectran and 1.4 specific gravity with six turns per inch is about 0.03 degrees with respect to the centerline or axis of the section of yarn. A range of about 0.01 to 0.05 degrees of helix angle is preferred.

The choice of twist should be as low as possible and still allow for realization of full tenacity of the yarn. As is well know, yarn tensile strength increases with some small amount of twist. This increase in tensile strength, however, beings to reverse itself at higher twist. A minimum twist level can be found for each material and yarn denier which gives the optimum tensile. Yarns at these twist levels are said to have high conversion efficiencies. In this regard, it has been unexpectedly discovered according to the present invention that lower twist yarns (lower helix angle) can provide the same or better flex fatigue as higher twist yarns, but at a much lower thickness and consequent weight on a proportional basis.

“Flex fatigue” is used herein to refer to the characteristics of the laminate with respect to bending stress loading. In regard, its use is very similar, and perhaps identical depending upon the circumstances, to the use of the term “fatigue testing” with respect to metals and other materials. A material can fail (i.e., break or suffer irreversible degradation of tensile properties) after repeated stress loading even if the stress level never exceeds the fundamental strength limits of the material. The behavior of the materials under repeated stress loading is typically evaluated by fatigue testing. In one form, a specimen is loaded repeatedly to a specific stress amplitude, and then the number of applications or repetitions of the stress that are required to cause failure is counted. Round specimens such as metal bars or rods are typically stress tested using rotational tests, but alternating deflection, or bending tests are more common for sheet materials such as laminates of the present invention. When these large airship fabric assemblies are built, inflated and deflated the fabric is folded or bent on itself. Those of ordinary skill in a number of arts are familiar with the concepts of bending flex fatigue and fatigue testing. A relatively straightforward exemplary discussion is given, for example, in Lindeburg, Engineer-in-Training Reference Manual, 8^{th} edition, Professional Publications, Inc. (1996) at pages 36-8 and 36-9.

With respect to the present invention, it has been conventionally understood that higher amounts of twist provide a greater resistance to bending flex fatigue, i.e., better bending flex fatigue performance. In conveyer and tire applications yarns are highly twisted for flex fatigue. Additional these high fatigue yarns are twisted in one direction and then plied together with twist in the other direction to make a larger corded structure.

As set forth in the background, however, greater twist in the yarns forming a fabric in laminate cause the yarns to take on a round cross-section and to be form in to thicker fabrics which in turn makes them heavier on a per unit area basis. As further se forth in the background, in order to completely fill the void spaces in such a laminate and/or to provide an appropriate gas barrier to such thick fabrics, a relatively large amount of polymer material (typically polyurethane) must be applied as a coating to such fabrics. Thus, yarns with higher twist, while providing satisfactory flex fatigue performance, add weight in their own right on a proportional basis, and similarly require a proportionately larger amount of added polymer weight when coated.

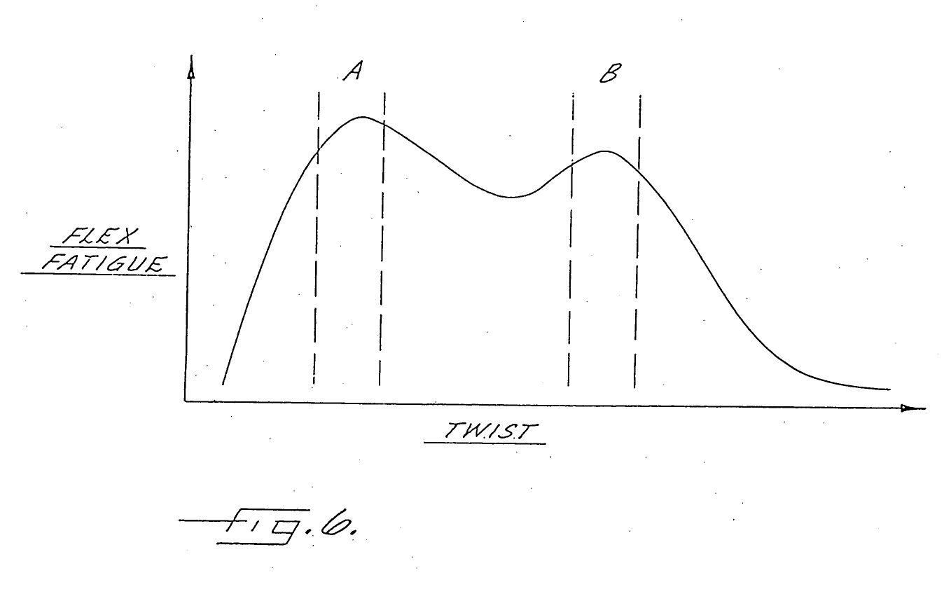

Generally speaking, starting from no twist whatsoever, the flex fatigue performance of a fabric made form twisted yarns increases with the amount of twist. It ahs now been discovered, however, that in airship laminates according to the present invention, the relationship between fatigue and twist is bi-modal in its characteristics. FIG. 6 illustrates this in graphical fashion in which flex fatigue performance is plotted against twist. The results are shown in a general (rather than specific) pattern that has been observed in connection with the present invention. Thus, conventionally yarns have been twisted to the degree defined by the zone B in FIG. 6. It is expected that this zone has improved flex fatigue because the thinner structure keeps more of the fiber near the low stress area in the bent laminate. As the yarns get rounder the fabric is thicker and the tensile and compressive stress on the inner and outer fiber go up rapidly. Most stress for a given bending angle leads to greater loss per bending cycle and hence less flex performance. The conventional twist approach while improving the flex fatigue of the base yarns also subjects them to a more damaging condition because of increased thickness.

The tensile strength of the material in general refers to the strength shown by a specimen subjected to tension as distinct from torsion, compression, or shear: Dictionary of Fiber & Textile Technology, supra. The tensile strength is typically measured as the breaking force per unit width. The tensile strength is reduced into the tenacity or tensile strength per unit denier or conventional units of grams per denier, Fairchild's Dictionary of Textiles, supra. The tensile strength of fabrics, and tensile strength of the fabric of the invention, are typically measured in the direction from other types of measurement such as bursting strength or tear strength, although tear strength is important to the present invention.

In turn, tear strength, represents the ability of the material to resist rupture by tearing. Tear strength is measured by the force required to start or to continue a tear in a fabric under specified conditions, In the case of airship materials the specific tear geometry of importance is the slit tear. In testing, the material is subjected to two-dimensional stress field. If the laminate is damaged in a collision, a slit or opening can be made in the laminate. The damage or slit in the material must not tend to grow under a stress field. If the slit grows the overall integrity of the airship could be put in question.

By using a fabric design which minimizes the number of crossing points the yarns can slide relative to one another. At the ends of a slit the stress field must break yarns to enlarge the damage. If the yarns, are able to slide together they will tend to share the stress or load. In this way, the low crossing point designs give high slit tear performance.

In addition to improved slit tear, the low crossing designs also reduce the thickness and weight of the laminate. In a plain weave or full knit the number of crossings is highest and the mobility of the yarns is lowest. In order for this structure to have high tear, the individual yarns must be proportionally larger. Because of larger yarns, the structure gets thicker. In preferred embodiments, the woven fabric has less than fifty percent (50%) of available crossing points formed, and in the most preferred embodiments, has less than twenty percent (20%) of available crossing points formed.

Adhesion represents the strength or state in which two surfaces are held together by interfacial forces, which in turn may consist of either valence forces or interlocking action, or both, Lewis, Hawley's Condensed Chemical Dictionary, 12th Edition, Van Nostrand Reinhold (1993).

In the construction of airship laminates the assembly of sections of the ship are joined with various types of overlapping and taped joints. The details of these joints are not the subject of this patent, are generally well-understood in this art, and will not otherwise be discussed herein. In general, however, all of these joints subject the laminates to shear forces as inflation and service loads are transmitted across the joints. These loads must be carried by the adhesive strength of the bonds between the matrix and the fiber. This shear force performance is the result of at least two factors: first the correct chemical adhesion promotion between the matrix resins and the fibers must be present; second the fiber layers must have a structure that resists the pull out of one layer of loaded fibers from the other layers. The number of crossing points between the fiber layers is important in preventing the delamination or pullout of the structure in the joint area.

The term “crimp” is used herein in its ordinary sense; i.e., the waviness of a fiber or filament expressed as percentage crimp. Crimp can also be expressed as the difference in distance between two points on an unstretched fiber and the same two points when the fiber is straightened under a specified tension. In such definitions, the crimp is expressed as a percentage of the unstretched length; Dictionary of Fiber & Textile Technology, supra.

The term “elongation” refers to the difference between the length of a stretched textile specimen and its initial length, expressed as a percentage of the initial length. It is measured at any specified load or at the breaking point) Fairchild's Dictionary of Textiles, supra.

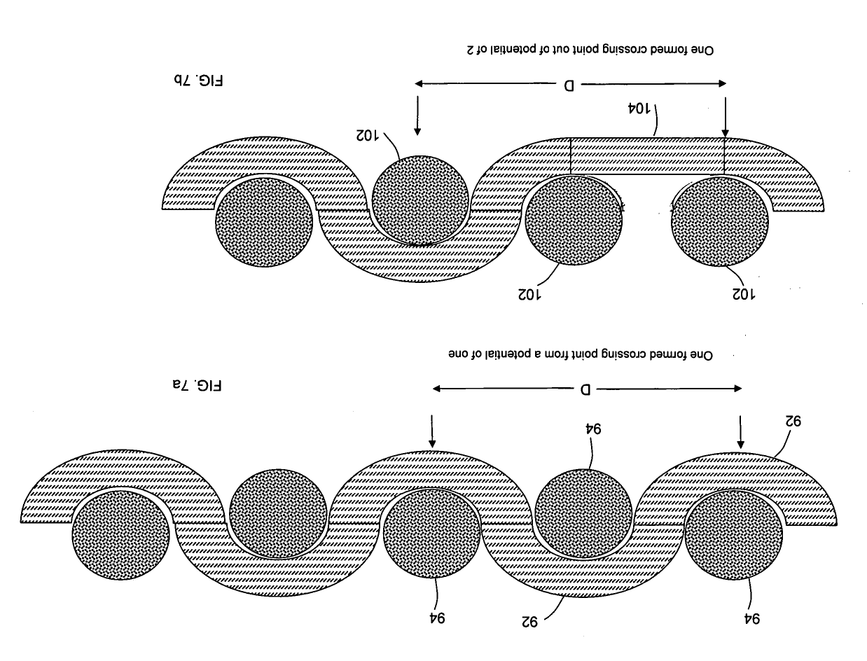

The terms “crossing point” “available crossing point”, “formed crossing point” and “locking point” in a woven fabric are well understood in the art and are relevant to the description of the invention. FIGS. 7A and 7B are provided to facilitate a clear understanding of the terms. Both figures show fill or cross machine yarns in cross section and warp or machine direction yarns running from left to right. A machine direction reference distance D of two times the cross machine yarn spacing is illustrated in both FIGS. 7A and 7B for comparative purposes. FIG. 7A is a simple cross section illustration of a warp or machine direction yarn 92, running from left to right alternately under and over each consecutive fill or cross machine yarn 94, crossing over from one side of the web to the other at every available opportunity, i.e. between every fill yarn. In other words, every available crossing point is utilized to become a formed crossing point. FIG. 7B, in contrast to FIG. 7A, illustrates machine direction yarn 102 remaining on one side of the web as it passes left to right under the first two consecutive cross machine yarns 104, then crossing over to the other side of the web between the second and third cross machine yarns 104 within the reference distance D. The FIG. 7B machine direction yarn 102 has formed one actual crossing point, or locking point, where two crossing points were available. Assuming all warp yarns are crossing over at every second fill yarn, this yields a warp yarn crossing point ratio of ½, or 50%; 1 formed crossing point from among each 2 available crossing points.

Expanding on the simple explanation above, an available crossing point within a fabric can be said to be present where ever a yarn intersects itself or another yarn in the plane of the fabric. For example, an available crossing point in a woven web can be said to be present for every warp yarn as to each fill yarn in its path or conversely for every fill yarn as to each warp yarn in its path, because each must cross the intersecting yarn on one side of the web or the other. The total number of available crossing points in a length of woven fabric can be calculated as the number of warp yarn ends multiplied by the number of fill yarn ends. A top view of a fabric discloses the total number of intersecting yarns, which is equal to the total number of available crossing points; but does not reveal without a perspective or side view, which or how many available crossing points have been utilized to create formed crossing points, or locking points as a formed crossing point may be described. This is evident in the example of the 2×2 weave in FIGS. 3 and 4.

A plain weave or a full knit consists of all or 100% formed crossing points, with other types of weaves or knits having progressively and proportionally less. For example, a normal 1×1 woven web or fabric employs all (100%) available crossing points as formed crossing points, while a 2×2 basket weave employs only 25% of the available crossing points. The proportion of actual formed crossing points to available crossing points for the fabric is simply the product of the warp ratio and the fill ratio; i.e. ½ warp crossing point ratio x ½ fill crossing point ratio equals ¼; or 25% formed crossing points.

Accordingly, in another aspect, the invention is a laminate wherein the yarn-to-fabric strength ratio of the fabric is between about 1:36 and 1:8. As used herein the term “strength ratio” represents the ratio of the strength of a single fiber group to the strength of the fabric as a whole on a per unit basis. Because the range 1:36 to 1:8 represents a ratio, any appropriate; and consistent measure of strength can be used. Tensile strength is one such appropriate measure, and in the case of the present invention, has been measured using a tensile testing machine setup to break both raveled strip fabric samples and single yarns samples. Tensile strength tests are well understood in the textile arts. As one example, ASTM D2990 provides an appropriate measure of tensile strength.

In evaluating the strength ratio, it has been determined that strength ratios less than about 1:8 tend to represent fiber groups that are too small to give tear performance of the degree required in airship applications. At the other end of the range, it has been determined that for strength ratios greater than 1:36, the individual fiber groups are too large to give the desired materials weigh or flex fatigue performance.

Returning to FIG. 2, the gas barrier that is laminated to the fabric layer is formed of a plurality of layers of materials, typically polymers. It will be understood that the barrier layers described herein are quite useful with the fabric of the present invention, but that the advantages offered by the fabric 20 of the present invention are not limited to the particular number of barrier layers, nor to their particular chemical composition. As will be understood by those with skill in the art, prior to lamination the fabric may be coated or set with a small amount of polymer coating (usually polyurethane) sometimes combined with cross linking chemistries (usually isocyanates) as necessary to improve processing and to achieve the required balance of physical properties in the final laminate.

As illustrated in FIG. 2, the airship laminate 17 includes a gas barrier formed of a first layer of polyurethane 21 on one face of the woven fabric layer. FIG. 2 illustrates the layer 21 as being on the helium side of the laminate 17. A second gas barrier layer, designated by the brackets 22, is formed of a plurality of layers of other materials. In the embodiment of FIG. 2, the second gas barrier layer 22 includes a layer of polyurethane 23 on the opposite side of the woven fabric 20 from the polyurethane layer 21. A layer of polyester film 24 is adjacent the polyurethane layer 23 and, among other uses, acts as a tie layer (i.e. a continuous adhesive bonding layer) between the polyurethane layer 23 and the additional external layers of material. Another layer of polyurethane 25 is on the opposite face of the polyester layer 24 from the polyurethane layer 23. The weather side of the laminate 17 is preferably completed with a layer of a fluorocarbon polymer 26 which in preferred embodiment is a polyvinyl fluoride, such as that available from DuPont under their Tedlar™ trademark.

For airship applications, the laminate should exhibit low gas permeability; it should preferably have a gas transmission rate (cm3-mm/24 h-m²-atm) of 30 or less for carbon dioxide (CO₂), 10 or less for oxygen (O₂), and 5 or less for nitrogen (N₂).

The polymers for the laminate, e.g., polyurethane, are commercially available. By convention, and for reasons of visibility and other purposes, the first gas barrier layer 21 is pigmented to a dark color, preferably black. The other polyurethane layer 23 that faces the woven fabric 20 is likewise pigmented black. Polyester layer 24 is typically unpigmented, while the outermost polyurethane layer 25 is pigmented black. The polyvinyl fluoride layer 26 forming the exterior of the laminate 17 is pigmented white and thus forms the external appearance of the laminate.

As known by those of ordinary skill in this art, the white pigment on the weather side of the laminate provides a reflective surface that reduces heat absorption, and certain white pigments can also block ultraviolet (UV) radiation, which otherwise tends to degrade many types of polymers, The black pigment on the gas side of the laminate also provides certain advantages, and in particular the black color makes the task of finding pin holes much easier.

An example of a FIG. 2 type embodiment is an unobvious and complex combination of seemingly unremarkable individual features, that offers surprisingly effective results. It can be described as a multiplicity of flexible layers continuously bonded together into a laminated structure that has designated interior and exterior sides. The several component layers of the laminate include a load bearing layer of flexible woven fabric where the woven fabric has an aggregate strength of greater than 10 grams per denier, a yarn to fabric strength ratio of between about 1.36 and 1.8, a yarn twist of less than 6 turns per inch, and a yarn height to width ratio of between about 1:2 and 1:7. An interior side gas barrier component or layer occurring on one side of the load bearing layer may consist of one or more layers of polyurethane or other materials.

An exterior side component or layer of the laminate structure occurring on the other side of the load bearing layer from the gas barrier component may include several layers in sequence. There may be a first layer of polyurethane, then a layer of film such as a polyester film or a polymeric material that is cast, extruded or drawn. There may then follow a second layer of polyurethane, and then an outermost layer of weather resistant polymeric material such as an alaphatic urethane or fluoropolymer such as Tedlar manufactured by EI DuPont Inc. This exterior side component may include other and further layers as well. The complete laminated structure has a gas transmission rate (cm³-mm/24 h-m²-atm) of preferably not more than 30 for carbon dioxide (CO₂), not more than 10 for oxygen (O₂), and not more than 5 for nitrogen (N₂), consistent with the low gas permeability objective of the invention.

FIG. 3 is a partial perspective view of the woven fabric 20 according to the present invention. As noted above, there are a number of characteristics of the woven fabric that are provided or enhanced by the present invention. Thus, in a first aspect, the woven fabric layer 20 can be considered to comprise a planar sheet or web of yarns 27 formed of high-strength manufactured fibers. The high-strength manufactured fibers can be any one of a number of synthetic fibers, provided they have the necessary strength for the overall laminate requirements Typically preferred materials for the yarns 27 include aromatic polyamide yarns, liquid crystal polyester yarns, and blends of these with each other or with other manufactured fibers of the required strength. As noted above, the woven fabric layer 20 preferably has an aggregate strength of at least 10 grams per denier.

By way of clarification, a “sheet” of yarns as used herein is intended to mean a single sheet of warp or weft yarns unless the context requires otherwise. A fabric layer might consist of one or a plurality of such sheets; and the threadline directions need not be aligned at 90 degrees as between respective sheets.

In a preferred embodiment, the woven fabric comprises a basket weave, and in a more preferred embodiment includes a 2×2 basket weave, which is the embodiment illustrated in FIG. 3. As set forth above, the 2×2 weave reduces the percentage of crossing points formed, and thus increases the performance of the overall laminate 17 in the manner described. The fabric can optionally include “looper” or “tie” yarns (not shown; these terms being well understood in the art) if desired in a particular fabric.

In a preferred embodiment, the woven fabric comprises a basket weave, and in a more preferred embodiment includes a 2×2 basket weave, as is illustrated in FIG. 3. As set forth above, the 2×2 weave reduces the percentage of formed crossing points and thus increases the performance of the overall laminate 17 in the manner described. In addition to having good tear and weight performance, a 2×2 basket weave retains enough crossing points to have adequate joint shear strength.

It will be understood that one preferred embodiment of the laminate of the invention can be formed using one such fabric layer; however the invention is not limited to a single fabric layer. Thus, to the extent appropriate based on weight and performance requirements, the laminate of the invention could comprise two or more fabric layers. The fabric layers may be secured together with tie yarns initially as well as with appropriate additional polymer material. If desired, the additional fabric layers can be oriented with a threadline bias with respect to one another. The thread lines of each layer need not be a conventional 90 degrees to each other. Given the stress field of the airship, thread line directions may be at other relative angles such as 30, 45 or 120 degrees. The fabric layers will have a continuously adhered or bonded interface in the finished laminate.

In another aspect of the invention, the fabric illustrated in FIG. 3 comprises yarns that have a cross-sectional height-to-width aspect ratio of between about 1:2 and 1:7. The term “cross-sectional aspect ratio” is used herein to distinguish the cross-sectional profile of the yarns 27 from their diameter-to-length aspect ratio which would, of course, be quite a different number and represent different physical characteristics; i.e., the overall length of the yarn compared to its diameter.

As noted earlier the fabric 20 illustrated in FIG. 3 can be characterized as having an aggregate strength greater than 10 grams per denier with the woven fabric 20 being formed of twisted yarns 27, and with the twisted yarns 27 having a helix angle no greater than that of a 1500 denier yarn at six twists per inch. Those familiar with the manufacture of yarns from filaments or fibers will recognize, of course, that the low twist gives the flat profile—and resulting advantages—of the yarns that have been described herein both subjectively and objectively.

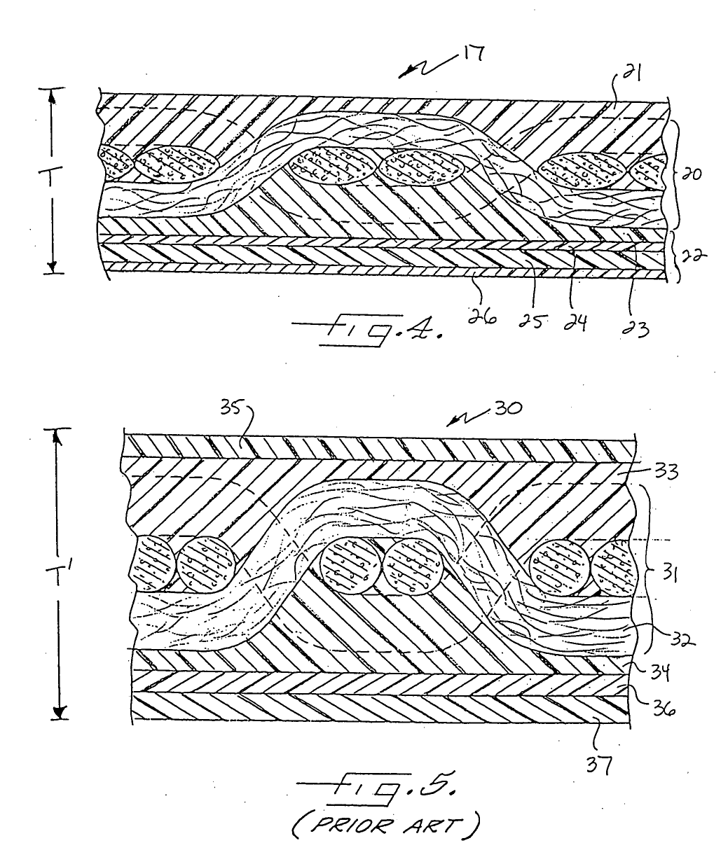

FIGS. 4 and 5 illustrate the differences between the laminate of the present invention and those of the prior art, including the advantages offered by the woven fabric 20 of the present invention. FIG. 4, a cross section of the embodiment of FIG. 2, shows the overall laminate broadly designated at 17 along with the individual polymer layers that make up a preferred embodiment. As in the embodiment illustrated in FIG. 2, the woven fabric is designated at 20, the first gas barrier layer at 21, and the second gas barrier layer at 22. In turn, the second gas barrier layer 22 is formed of the black pigmented polyurethane layer 23 immediately adjacent the woven fabric 20, the polyester tie layer 24 adjacent the black polyurethane layer 23, another layer of polyurethane 25 that is typically pigmented white, and the most external, weather facing side layer 26 formed of polyvinyl fluoride.

As illustrated in FIG. 4, the woven fabric 20 has the flat yarns that have been previously described herein. Because the overall width profile of the yarns is more narrow than conventional yarns, the resulting overall profile of the woven fabric 20, and thus the overall thickness T can be minimized. Perhaps most importantly, the amount of polyurethane in the layers 21 and 23 that provide the integrity for the overall laminate can be somewhat minimized.

Prior art FIG. 5 is included herein as a representative view of a cross-sectional profile of prior art laminates for aerostat applications. The overall laminate is broadly designated at 30 and includes a woven fabric indicated by the brackets 31 that is formed of conventional round yarns 32 which are fully twisted from the desired high-strength fibers. Because these conventional yarns 32 are significantly more fully twisted than those of the FIG. 4 embodiment, they tend to be relatively bulky resulting in a relatively thick woven fabric 31. In turn, when the woven fabric 31 is coated with a polymer, again typically polyurethane, to form the respective layers 33 and 34, a much thicker, and thus heavier, layer of polymer or polyurethane must be applied to each side of the woven fabric 31. The laminate 30 of FIG. 5 also includes several additional interior and exterior layers which are designated for illustration purposes as an additional layer 35 on the polyurethane layer 33, and respective layers 36 and 37 on the opposite side of the fabric and laminate to polyurethane layer 34.

In practice the weight advantage as between the laminate of the invention of FIG. 4 and prior art as illustrated in FIG. 5 can be as much as 13 ounces per square yard. Thus, if a typical airship were to have approximately 40,000 square yards of material, the total weight savings would be more than 16 tons. To be able to achieve such a significant weight savings over the contemporary industry standard without sacrificing performance otherwise is an unexpected and quite remarkable achievement, indicative of the importance of this invention within this field of art.

The invention is susceptible of many variations. In a first example, there is within the scope of the invention a laminated, load bearing structure with a designated high pressure interior side and low pressure exterior side, for confining a gas under pressure, where the laminate structure consists of a multiplicity of flexible layers of differing characteristics are oriented and continuously bonded together such that the performance characteristics of the whole is greater than the sum of its parts. The layers consist of the following: a distributed load bearing layer of flexible woven fabric, an interior side gas barrier layer on one side of said load bearing layer, and an exterior side layer on the other side of said load bearing layer. The flexible woven fabric has an aggregate strength of greater than 10 grams per denier, the yarns of the flexible woven fabric may have a yarn to fabric strength ratio of between about 1.36 and 1.8, a yarn twist of less than 6 turns per inch, and a yarn height to width ratio of between about 1:2 and 1:7. The gas barrier layer may be or have a layer of polyurethane. The exterior side layer consists of, in sequence; a first layer of polyurethane, a layer of film, a second layer of polyurethane, and an outermost layer of polymeric material. The laminated structure has a gas transmission rate of not more than about 5 liters in 24 hours through a one meter square area at a one atmosphere pressure differential.

In another similar example to that above, the flexible woven fabric has an aggregate strength of greater than 10 grams per denier, the yarns of the flexible woven fabric have a yarn twist of less than 6 turns per inch, and a yarn height to width ratio of between about 1:2 and 1:7, and the flexible woven fabric has not more than 50% of the available crossing points formed.

In yet another example similar to the first example, there is an additional fabric layer consisting of at least one sheet of yarns, the threadlines of which are not aligned with the threadlines of the flexible woven fabric. Also, the gas barrier layer may use polyurethane or other polymeric material. The gas transmission rate in any of these examples may be a transmission rate for helium or some other desired gas or mixture of gases. The flexible woven fabric may use a weave pattern of greater than a repetitive 1×1, such as a 2×2 basket weave. The first and second layers of the exterior side layer may be or use polyurethane or polymeric materials other than polyurethane. The interior side gas barrier layer may be or include black pigmented polyurethane. The outermost layer of polymeric material may be or include white pigmented fluorocarbon polymer. The flexible woven fabric may consist of a plurality of fabric layers where each layer is at least one sheet of yarns.

In the drawings and specification, there have been disclosed typical embodiments of the invention, and, although specific terms have been employed, they have been used in a generic and descriptive sense only and not for purposes of limitation, the scope of the invention being set forth in the following claims.

What is claimed is:

1. A laminated, load bearing structure with a designated high pressure interior side and low pressure exterior side, said structure comprising a multiplicity of flexible layers continuously bonded together wherein said layers comprise:
a load bearing layer of flexible woven fabric, said flexible woven fabric having an aggregate strength of greater than 10 grams per denier, the yarns of said flexible woven fabric having a yarn to fabric strength ratio of between about 1.36 and 1.8, a yarn twist of less than 6 turns per inch, and a yarn height to width ratio of between about 1:2 and 1:7;
an interior side gas barrier layer on one side of said load bearing layer, said gas barrier layer comprising a layer of polyurethane; and
an exterior side layer on the other side of said load bearing layer, said exterior side layer comprising in sequence,
a first layer of polyurethane,
a layer of film,
a second layer of polyurethane, and
an outermost layer of polymeric material;
said laminated structure having a gas transmission rate of not more than about 5 liters in 24 hours through a one meter square area at a one atmosphere pressure differential.

2. A laminated, load bearing structure with a designated high pressure interior side and low pressure exterior side, said structure comprising a multiplicity of flexible layers continuously bonded together wherein said layers comprise:
a load bearing layer of flexible woven fabric, said flexible woven fabric having an aggregate strength of greater than 10 grams per denier, the yams of said flexible woven fabric having a yarn twist of less than 6 turns per inch, and a yarn height to width ratio of between about 1:2 and 1:7, said flexible woven fabric having not more than 50% of available crossing points formed;
an interior side gas barrier layer on one side of said load bearing layer, said gas barrier layer comprising a layer of polyurethane; and
an exterior side layer on the other side of said load bearing layer, said exterior side layer comprising in sequence,
a first layer of polymeric material,
a layer of film,
a second layer of polymeric material,
an outermost layer of polymeric material;
said laminated structure having a gas transmission rate of not more than about 5 liters in 24 hours through a one meter square area at a one atmosphere pressure differential.

3. A laminated, load bearing structure with a designated high pressure interior side and low pressure exterior side, said structure comprising a multiplicity of flexible layers continuously bonded together wherein said layers comprise:
a load bearing layer of flexible woven fabric, said flexible woven fabric having an aggregate strength of greater than 10 grams per denier, the yarns of said flexible woven fabric having a yarn twist of less than 6 turns per inch, and a yarn height to width ratio of between about 1:2 and 1:7, said flexible woven fabric having not more than 50% of available crossing points formed;
an additional fabric layer comprising at least one sheet of yarns, the threadlines of which are not aligned with the threadlines of said flexible woven fabric;
an interior side gas barrier layer on one side of said load bearing layer, said gas barrier layer comprising a layer of polymeric material; and
an exterior side layer on the other side of said load bearing layer, said exterior side layer comprising in sequence,
a first layer of polymeric material,
a layer of film,
a second layer of polymeric material,
an outermost layer of polymeric material;
said laminated structure having a gas transmission rate of not more than about 5 liters in 24 hours through a one meter square area at a one atmosphere pressure differential.

4. A laminated, load bearing structure according to claim 1, said flexible woven fabric comprising less than 50% of available crossing points formed.

5. A laminated, load bearing structure according to claim 1, said flexible woven fabric comprising less than 20% of available crossing points formed.

6. A laminated, load bearing structure according to claim 1, said gas transmission rate comprising a helium transmission rate.

7. A laminated, load bearing structure according to claim 1, said flexible woven fabric comprising a weave pattern of greater than a repetitive 1×1.

8. A laminated, load bearing structure according to claim 1, said flexible woven fabric comprising a 2×2 basket weave.

9. A laminated, load bearing structure according to claim 1, said interior side gas barrier layer comprising black pigmented polyurethane.

10. A laminated, load bearing structure according to claim 1, said outermost layer of polymeric material comprising white pigmented fluorocarbon polymer.

11. A laminated, load bearing structure according to claim 1, said yarns comprising yarns selected from the group consisting of aromatic polyamide yarns, liquid crystal polyester yarns, and blends thereof.

12. A laminated, load bearing structure according to claim 1, said flexible woven fabric comprising a plurality of fabric layers wherein each layer consists of at least one sheet of yarns.

13. A laminated, load bearing structure according to claim 2, said gas transmission rate comprising a helium transmission rate.

14. A laminated, load bearing structure according to claim 2, said flexible woven fabric comprising a weave pattern of greater than a repetitive 1×1.

15. A laminated, load bearing structure according to claim 2, said flexible woven fabric comprising a 2×2 basket weave.

16. A laminated, load bearing structure according to claim 2, said interior side gas barrier layer comprising black pigmented polyurethane.

17. A laminated, load bearing structure according to claim 2, said polymeric materials of said first and second layers of said exterior side layer comprising polyurethane.

18. A laminated, load bearing structure according to claim 3, said polymeric materials of said first and second layers of said exterior side layer comprising polyurethane.

19. A laminated, load bearing structure according to claim 3, said outermost layer of polymeric material comprising white pigmented fluorocarbon polymer.

20. A laminated, load bearing structure according to claim 3, said yarns comprising yarns selected from the group consisting of aromatic polyamide yarns, liquid crystal polyester yarns, and blends thereof.

21. A laminated, load bearing structure according to claim 3, said flexible woven fabric comprising a plurality of fabric layers wherein each layer consists of at least one sheet of yarns.

22. A laminated, load bearing structure according to claim 3, said flexible woven fabric comprising a 2×2 basket weave.
